(19) United States
(12) Patent Application Publication
(10) Pub. No.: US 2006/0092447 A1
(43) Pub. Date: May 4, 2006

(54) Printing device and corresponding printing method used therein

(75) Inventors: Atsushi Narusawa, Nagano-ken (JP); Satoru Orii, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/976,317

(22) Filed: Oct. 29, 2004

(51) Int. Cl. G06K 15/00

(52) U.S. Cl. 358/1.13; 358/1.18; 358/1.9

(57) ABSTRACT

When a page size extracted from a style object created by analysis of a CSS document is greater than a paper size set in a printer, the technique of the invention updates the page size to the paper size, limits the size of the style object to a maximum allowable size of an element set according to the paper size, and lays out and prints elements based on the updated page size and the limited size of the style object. This arrangement desirably prevents potential troubles due to the greater page size than the printing size, for example, failed printing of part of the elements to be printed.

### BACKGROUND OF THE INVENTION

1. Field of the Invention

The present invention relates to a printing device and a corresponding printing method used therein. More specifically the invention pertains to a printing device that analyzes a description document, which describes printable objects in a hierarchical manner in a preset first format, and prints the objects on a medium, such as paper, as well as to a corresponding printing method executed in the printing device in response to specification of a description document that describes printable objects in a hierarchical manner in a preset format, to analyze the specified description document and print the objects on a medium.

2. Description of the Prior Art

One proposed printer system includes a printer that analyzes and prints an SVG document and a formatting server that converts an HTML document into the SVG document (see, for example, Japanese Patent Laid-Open Gazette No. 2002-91726). In this proposed printer system, the formatting server converts a received HTML document into an SVG document, and the printer analyzes and prints the converted SVG document.

### SUMMARY OF THE INVENTION

This prior art printer system including the printer and the formatting server is, however, undesirably large in size and is unsuitable for a restricted space, such as a living room in a house. This printer system converts the received HTML document into the SVG document and analyzes and prints the converted SVG document. Such conversion and analysis take a relatively long time and undesirably interfere with prompt printing. Output of a laid-out document with setting of a certain printing size to a printer with another size of printing paper may cause an unexpected result, for example, failed printing of part of the document.

The printing device of the invention and the corresponding printing method used therein aim to adequately print a description document, which describes objects in a hierarchical manner in a preset format, for example, an HTML document or extended XHTML document. The printing device of the invention and the corresponding printing method used therein also aim to promptly analyze and print a description document, which describes objects in a hierarchical manner in a preset format, for example, an HTML document or extended XHTML document.

At least part of the above and the other related objects is attained by a printing device and a corresponding printing method of the invention constructed as discussed below.

The printing device of the invention is the printing device that analyzes a description document, which describes printable objects in a hierarchical manner in a preset first format, and prints the objects on a medium, such as paper, and the printing device includes: a data storage module that stores data; a structural analysis module that analyzes a hierarchical tree structure of objects described in a given description document and stores the analyzed tree structure into the data storage module; a style analysis module that analyzes a style document, which describes a printing style of the objects in a preset second format, and stores style data given as a result of the analysis into the data storage module; an analysis instruction module that, in response to specification of a description document, gives a structure analysis command to the structural analysis module to analyze the tree structure of the specified description document, gives a style analysis command to the style analysis module to analyze a style document described in the specified description document and generate style data as a result of the analysis, and correlates the analyzed tree structure with the generated style data; a layout setting module that, in response to a layout command, determines a layout of the objects in each page on the medium, based on the tree structure analyzed and stored in the data storage module, the style data correlated with the tree structure, and a size of the medium, and stores the determined layout in each page into the data storage module; and a print execution module that, in response to a print command, fetches the objects according to the layout in each page stored in the data storage module and lays out and prints the fetched objects on the medium.

In response to specification of a description document, the printing device of the invention analyzes the tree structure of the specified description document, analyzes a style document described in the specified description document to generate style data as a result of the analysis, and correlates the analyzed tree structure with the generated style data. In response to a subsequent layout command, the printing device determines a layout of the objects in each page on the medium, based on the tree structure analyzed and stored in the data storage module, the style data correlated with the tree structure, and a size of the medium. In response to a subsequent print command, the printing device fetches the objects according to the layout in each page stored in the data storage module and lays out and prints the fetched objects on the medium. The printing device of the invention lays out and prints the description document by taking into account the size of the medium. This arrangement desirably prevents unexpected troubles due to printing of a laid-out document based on only the tree structure and the style data, for example, failed printing of part of the description document due to a greater page size than the size of the medium, thus ensuring appropriate printing of the description document. The document may be described in a markup language, such as XHTML language. The printable objects include texts, images, and tables. One typical example of the printing device is a color inkjet printer.

The printing method of the invention is the printing method executed in a printing device in response to specification of a description document that describes printable objects in a hierarchical manner in a preset format, to analyze the specified description document and print the objects on a medium, and the printing method includes the steps of: (a) analyzing a hierarchical tree structure of the objects in the specified description document; (b) analyzing a style document described in the specified description document to generate style data representing a printing style of the objects as a result of the analysis; (c) correlating the analyzed tree structure with the generated style data; (d) in response to a layout command, determining a layout of the objects in each page on the medium, based on the analyzed tree structure, the style data correlated with the tree structure, and a size of the medium; and (e) in response to a print command, fetching the objects according to the determined layout in each page and laying out and printing the fetched objects on the medium.

In response to specification of a description document, the printing method of the invention analyzes the tree structure of the specified description document, analyzes a style document described in the specified description document to generate style data as a result of the analysis, and correlates the analyzed tree structure with the generated style data. In response to a subsequent layout command, the printing method determines a layout of the objects in each page on the medium, based on the analyzed tree structure, the style data correlated with the tree structure, and a size of the medium. In response to a subsequent print command, the printing method fetches the objects according to the determined layout in each page and lays out and prints the fetched objects on the medium. The printing method of the invention lays out and prints the description document by taking into account the size of the medium. This arrangement desirably prevents unexpected troubles due to printing of a laid-out document based on only the tree structure and the style data, for example, failed printing of part of the description document due to a greater page size than the size of the medium, thus ensuring appropriate printing of the description document.

In the printing method of the invention, the style data may include a page size, and when the page size included in the style data is greater than the size of the medium, the step (d) may determine the layout according to the size of the medium, instead of the page size. In this case, the style data may include a size of an object, and when the size of the object included in the style data is greater than a maximum allowable object size corresponding to the size of the medium, the step (d) may determine the layout according to the maximum allowable object size, instead of the size of the object.

In the printing method of the invention, in the case of execution of a printing operation of another description document specified prior to specification of a certain description document, the step (a) may start analysis of the tree structure of the certain description document after completion of analysis of the tree structure of the another description document, regardless of execution or non-execution of the printing operation.

Further, in the printing method of the invention, the printing device has a data storage module of storing data, and the step (a) may store the analyzed tree structure into the data storage module. In response to the layout command with specification of the tree structure stored in the data storage module, the step (d) may determine the layout based on the specified tree structure. In this case, the step (d) may output a predetermined termination signal after completion of determination of a layout based on a previously analyzed tree structure, and in response to a next layout command with specification of a currently analyzed tree structure, which is subsequent to the previously analyzed tree structure with the output of the predetermined termination signal, the step (d) may determine a layout based on the currently analyzed tree structure.

Furthermore, in the printing method of the invention, the step (d) may give the print command with regard to each page on completion of determination of the layout for the page. The step (d) may also give the print command on completion of determination of the layout for one page.

In the printing method of the invention, the printing device has a data storage module of storing data, the step (b) may retrieve style data corresponding to a style document described in the specified description document with identification information allocated to the style document for its identification from said data storage module, in the case of failed retrieval of the style data corresponding to the described style document from the data storage module, the step (b) may execute analysis of the style document and store the identification information of the analyzed style document in relation to style data generated as a result of analysis of the style document in the data storage module, while in the case of successful retrieval of the style data corresponding to the described style document from the data storage module, the step (b) may omit analysis of the style document, and in the case of failed retrieval of the style data corresponding to the style document described in the specified description document with the identification information allocated to the style document for its identification from the data storage module, the step (c) may correlate the tree structure analyzed in the step (a) with the style data generated as a result of the analysis in the step (b), while in the case of successful retrieval of the style data corresponding to the described style document from the data storage module, the step (c) may correlate the tree structure analyzed in the step (a) with the corresponding style data.

Further, in the printing method of the invention, the step (d) may determine the layout according to specification or non-specification of rimless printing.

### BRIEF DESCRIPTION OF THE DRAWINGS

FIG. 1 schematically illustrates the structure of a color inkjet printer 20 in one embodiment;

FIG. 2 is a flowchart showing an analysis layout instruction process;

FIG. 3 is a flowchart showing an analysis process;

FIG. 4 shows one example of an XHTML document;

FIG. 5 shows images described in the XHTML document of the example;

FIG. 6 shows one example of a DOM tree;

FIG. 7 shows one example of a CSS document;

FIG. 8 shows one example of a style object;

FIG. 9 is a flowchart showing a layout drawing instruction process;

FIG. 10 is a flowchart showing a layout process;

FIG. 11 shows one example of a page box;

FIG. 12 is a flowchart showing a drawing process; and

FIG. 13 shows one example of a printing result.

### DESCRIPTION OF THE PREFERRED EMBODIMENTS

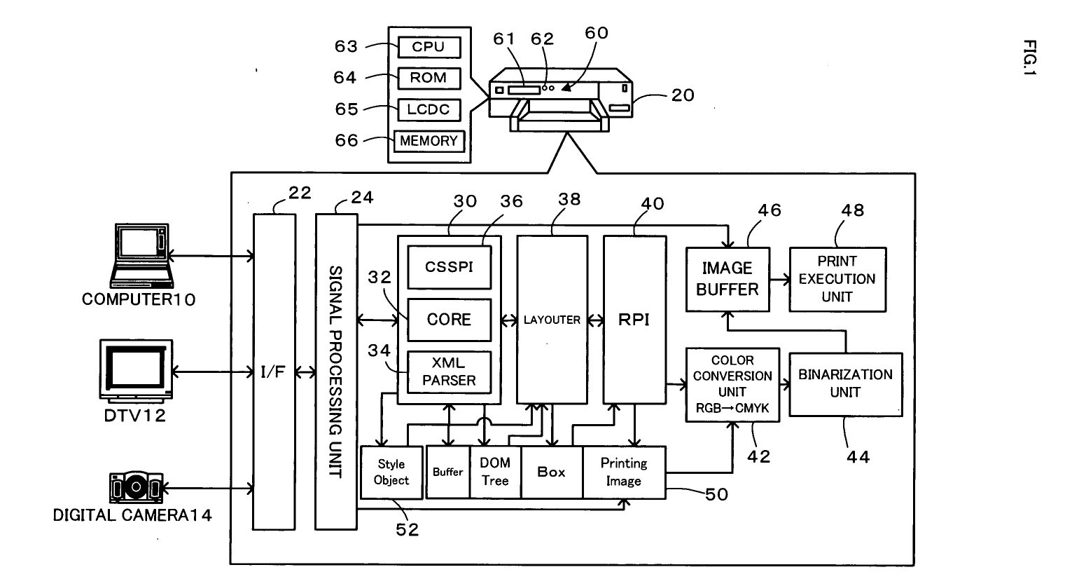

One mode of carrying out the invention is described below as a preferred embodiment. FIG. 1 schematically illustrates the structure of a color inkjet printer 20 in one embodiment of the invention. The color inkjet printer 20 of this embodiment includes an input interface 22 that is connected with a computer 10, a digital TV receiver 12, or a digital camera 14 to input digital images (hereafter simply referred to as images), a signal processing unit 24 that determines an output destination of data according to the format of each image input by the input interface 22, and an analyzer unit 30 that analyzes an XHTML document described in a markup language XHTML (extensible Hyper Text Markup Language) to create a DOM (Document Object Model) tree as an object tree structure and writes the DOM tree into a memory 50, while reading a CSS (Cascading Style Sheets) document described in CSS to create a style object and writing the style object into a flash memory 52. The color inkjet printer 20 also includes a layouter 38 that lays out images and text as objects described in the XHTML document on each printing page based on the DOM tree and the style object created by the analyzer unit 30 and writes each laid out printing page as a page box into the memory 50, a rendering plug-in (hereafter referred to as RPI) that draws a printing image in the form of RGB (red, green, blue) data by utilizing the page box laid out by the layouter 38, a color conversion unit 42 that converts a printing image of the drawn RGB data into CMYK (cyan, magenta, yellow, black) data, a binarization unit 44 that makes the converted CMYK data subjected to error diffusion or another required series of image processing to binarize the CMYK data, an image buffer 46 that temporarily accumulates data in order to output the binarized CMYK data in units of bands to a print execution unit 48 with a non-illustrated print head, and an operation unit 60 that is operated for various settings.

The signal processing unit 24 outputs immediately-printable print data to the image buffer 46 of the print execution unit 48, RGB data to a printing image storage area of the memory 50, and a file of the XHTML document to the analyzer unit 30.

The analyzer unit 30 includes a core 32 that gives an analysis command for analysis of the XHTML document to create the DOM tree, an XML parser 34 that analyzes the XHTML document in response to the analysis command given by the core 32, and a CSS plug-in (hereafter referred to as CSSPI) 36 that analyzes the CSS document in response to a request given by an initialization process in a link tag of the created DOM tree.

The operation unit 60 includes a liquid crystal display 61 that is located on the front side of the printer 20, two operation buttons 62 provided by the side of the liquid crystal display 61, and a one-chip microcomputer including a CPU 63, a ROM 64, a display controller (hereafter referred to as LCDC) 65, and a memory 66. The operation unit 60 is manipulated to set, for example, the type and size of printing paper and the type of inks set in the printer 20. In response to the user's push of the operation button 62, a processing program stored in advance in the ROM 64 is activated to display a menu for settings on the liquid crystal display 61. For example, the user selects a paper size option in the displayed menu and chooses a desired paper size among available options, such as ‘A4 Portrait’ and ‘B4 Portrait’, displayed in toggle on the liquid crystal display 61. The selected settings are written into the memory 66. In the structure of this embodiment, prior to the user's individual settings through manipulation of the operation unit 60, there are default settings, for example, ‘Plain Paper’ as the paper type, ‘A4 Portrait’ as the paper size, and ‘Pigment’ as the ink type. The user's settings by the operation unit 60 are not characteristic of the present invention and are thus not described in detail.

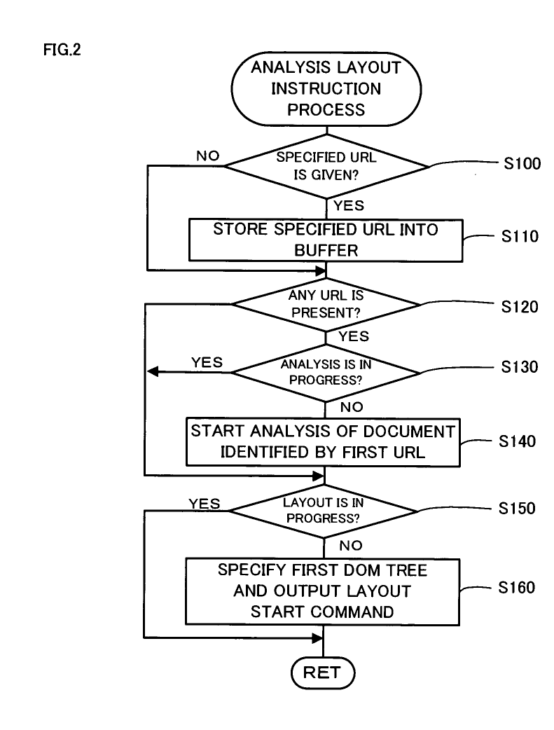

The following describes operations of the color inkjet printer 20 of the embodiment constructed as discussed above, especially a series of operations to print an XHTML document. FIG. 2 is a flowchart showing an analysis layout instruction process executed by the analyzer unit 30. This process is executed repeatedly at preset time intervals (for example, at every 8 msec). In the analysis layout instruction process, the analyzer unit 30 first determines whether a specified URL (Uniform Source Locator) is given to identify an XHTML document (step S100). When a specified URL is given, the URL is stored in a URL storage buffer area set in the memory 50 (step S110). When no specified URL is given, on the other hand, the program proceeds to a next step. The specified URL may be output, for example, from the digital TV receiver 12 to the color inkjet printer 20 when the operator selects a desired option to be printed by the color inkjet printer 20 among printable options displayed on the digital TV receiver 12. The specified URL may be selected simply by the computer 10 to give a print command to the color inkjet printer 20. The computer 10 has functions of executing analysis of the XHTML document, layout, color conversion, and binarization. The computer 10 may, however, not execute any of such processing but may send only the specified URL to the color inkjet printer 20.

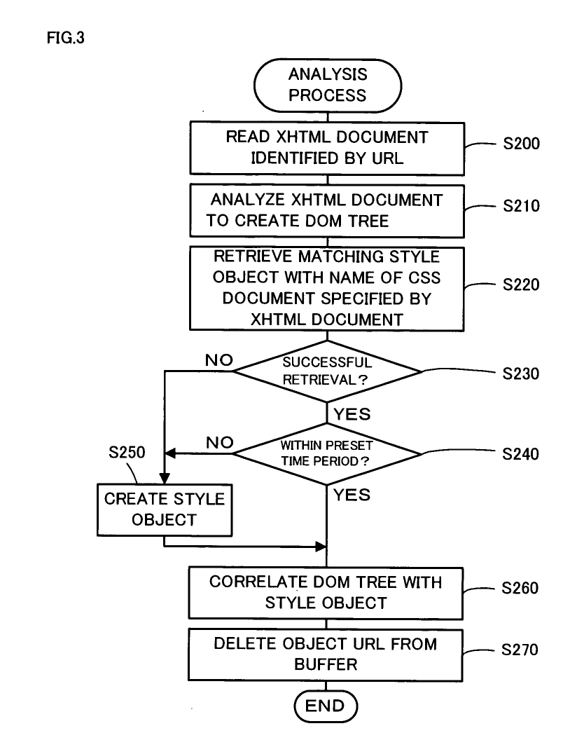

The analyzer unit 30 subsequently determines whether any URL is present in the URL storage buffer area of the memory 50 (step S120) and whether any XHTML document is currently being analyzed (step S130). The analyzing status of an XHTML document is detected, for example, by determining whether the analyzer unit 30 is currently analyzing any XHTML document, simultaneously with and in parallel with this analysis layout instruction process. One concrete procedure may set and reset a flag at the start and the end of analysis. When any URL is present in the URL storage buffer area and no XHTML document is currently being analyzed, the analyzer unit 30 reads out a first URL stored in the URL storage buffer area of the memory 50 and starts analysis of an XHTML document specified by the read out URL (step S140). When no URL is present in the URL storage buffer area or when any URL is present but an XHTML document is currently being analyzed, on the other hand, the program proceeds to a next step. Analysis of the XHTML document is carried out according to an analysis process shown in FIG. 3. The analysis process analyzes an XHTML document specified by a URL to create a DOM tree and stores the DOM tree into a DOM tree storage area of the memory 50 after allocation of a DOM tree ID as identification information to the DOM tree. The analysis process also analyzes a CSS document specified by the XHTML document to create a style object and stores the style object into the flash memory 52 after allocation of a style object ID (the name of the CSS document in this embodiment) as identification information to the style object. The details of the analysis process will be discussed later.

The analyzer unit 30 then determines whether the layouter 38 is currently making a layout (step S150). When the layouter 38 is not currently making a layout, the analyzer unit 30 specifies a first DOM tree with the DOM tree ID among DOM trees stored in the DOM tree storage area of the memory 50 and outputs a layout start command to the layouter 38 (step S160), before terminating this analysis layout instruction process. When the layouter 38 is currently making a layout, on the other hand, the analyzer unit 30 terminates the analysis layout instruction process without outputting a layout start command. The layout execution status of the layouter 38 is determined, for example, by detection of input of a layout end signal from the layouter 38. The input of the layout end signal will be described later as part of the processing by the layouter 38.

The analysis layout instruction process is executed in a repeated manner as mentioned above. Every time a specified URL is given, the analyzer unit 30 stores the specified URL into the URL storage buffer area of the memory 50, whether or not an XHTML document is being analyzed. When any URL is present in the URL storage buffer area of the memory 50, the analyzer unit 30 successively analyzes XHTML documents, whether or not the layouter 38 is currently making a layout. This may result in storage of multiple URLs and storage of multiple DOM trees respectively in the URL storage buffer area and in the DOM tree storage area of the memory 50, as well as storage of multiple style objects in the flash memory 52. In the structure of this embodiment, the URL storage buffer area and the DOM tree storage area are respectively set to have the capacities for storage of the multiple URLs and the multiple DOM trees, while the capacity of the flash memory 52 is reserved for storage of the multiple style objects.

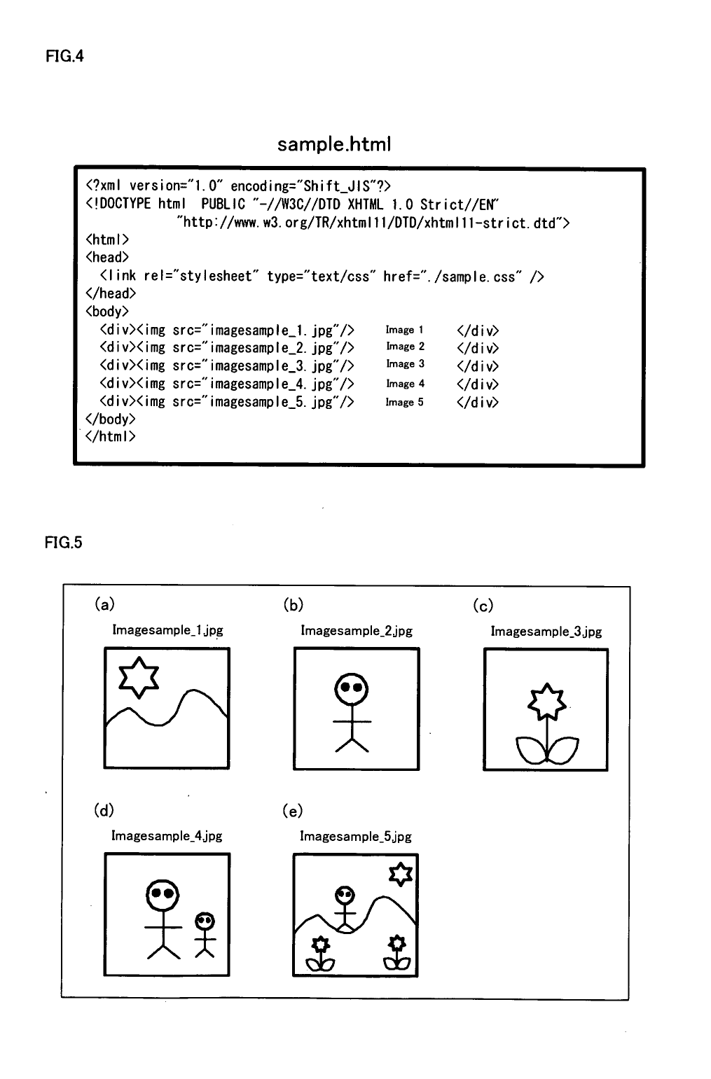

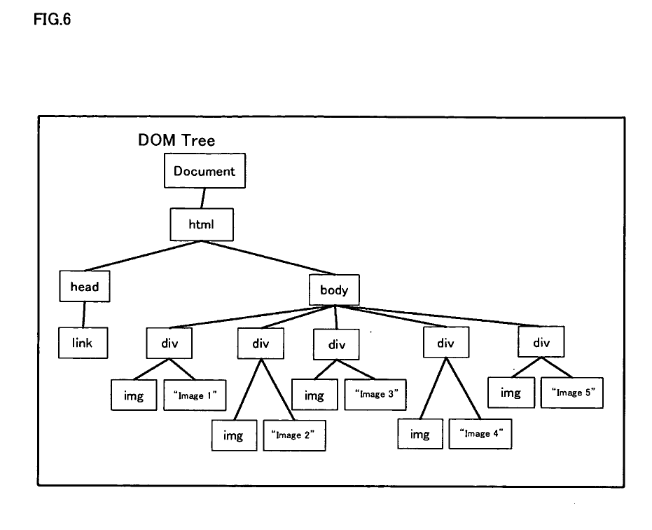

The description regards the analysis process executed by the analyzer unit 30. The analysis process is carried out according to the flowchart of FIG. 3 as mentioned above. As a matter of convenience, the description of the analysis process regards an XHTML document shown in FIG. 4 as one example. FIG. 5 shows five images stored in the JPEG format adopted in the XHTML document of the example. When the analysis layout instruction process outputs an analysis start command with a specified URL, the analyzer unit 30 reads an XHTML document identified by the specified URL (step S200) and analyzes the XHTML document to create a DOM tree (step S210). A DOM tree ID (for example, an ID prepared by adding a DOM to a URL) is assigned as identification information to the created DOM tree. According to the concrete procedure, the core 32 specifies a URL and gives an analysis request to the XML parser 34. The XML parser 34 reads the XHTML document specified by the URL and sequentially analyzes the XHTML document from the top to create respective elements and register the created elements in the form of a DOM tree. The XML parser 34 correlates the created elements and registers the correlated elements in the DOM tree storage area of the memory 50. FIG. 6 shows a DOM tree created by analysis of the XHTML document of FIG. 4.

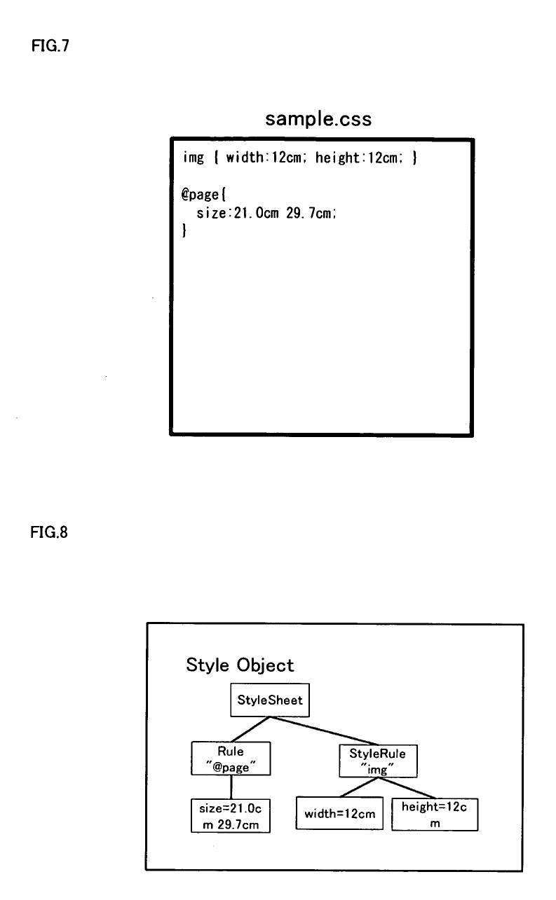

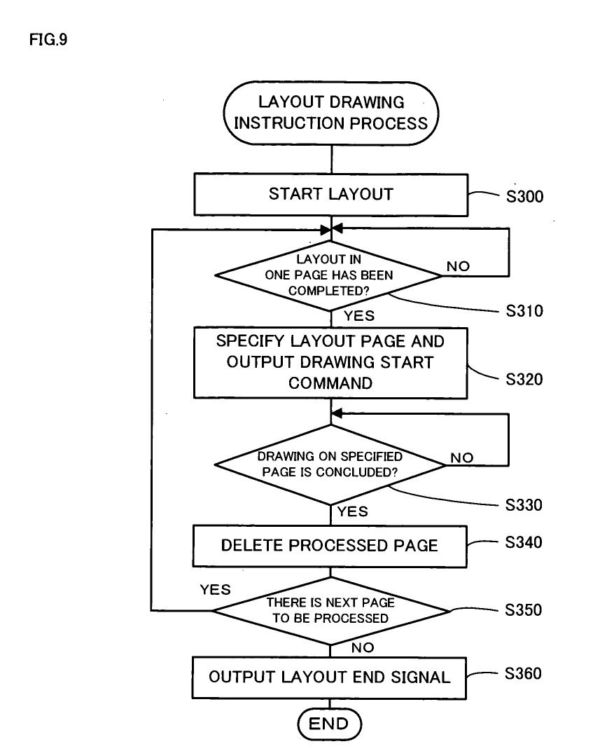

After creation of the DOM tree, the analyzer unit 30 retrieves a matching style object with the specified style object ID, that is, the name of the CSS document specified by the XHTML document, from the flash memory 52 (step S220). In the case of failed retrieval of any matching style object in the flash memory 52, the analyzer unit 30 reads a CSS document specified by the XHTML document and analyzes the CSS document to create a style object (step S250). According to the concrete procedure, the CSSPI 36 reads the specified CSS document in response to a request given in an initialization process in a link tag of the created DOM tree, sequentially analyzes the CSS document from the top to create rules as a style object, and stores the created style object into the flash memory 52. The CSSPI 36 sets the name of the CSS document to the style object ID and correlates the date and time of creation of the style object and the style object ID with storage of the style object in the flash memory 52. FIG. 7 shows a CSS document specified by the XHTML document of the example. FIG. 8 shows a style object created by analysis of this CSS document.

In the case of successful retrieval of a matching style object with the specified style object ID or the name of the CSS document specified by the XHTML document in the flash memory 52, on the other hand, the analyzer unit 30 determines whether the date and time of storage of the matching style object is within a preset time period (step S240). The preset time period is specified arbitrarily, for example, 1 day, 3 days, 1 week, or 1 month. Comparison between the date and time of storage of the style object and the preset time period is required here, since the CSS document may be updated and rewritten. When the date and time of storage of the style object is beyond the preset time period, the analyzer unit 30 reads a CSS document specified by the XHTML document and analyzes the CSS document to create a style object (step S250), as in the case of failed retrieval of the matching style object. The created style object is stored with the corresponding name of the CSS document as the style object ID in the flash memory 52. Namely the style object with the identical style object ID in storage of the flash memory 52 is overwritten by the newly created style object.

After creation of the style object or in response to determination that the date and time of storage of the matching style object in the flash memory 52 is within the preset time period, the analyzer unit 30 correlates the created DOM tree with the style object (step S260) and deletes the URL as the object of analysis from the URL storage buffer area (step S270), before terminating the analysis process.

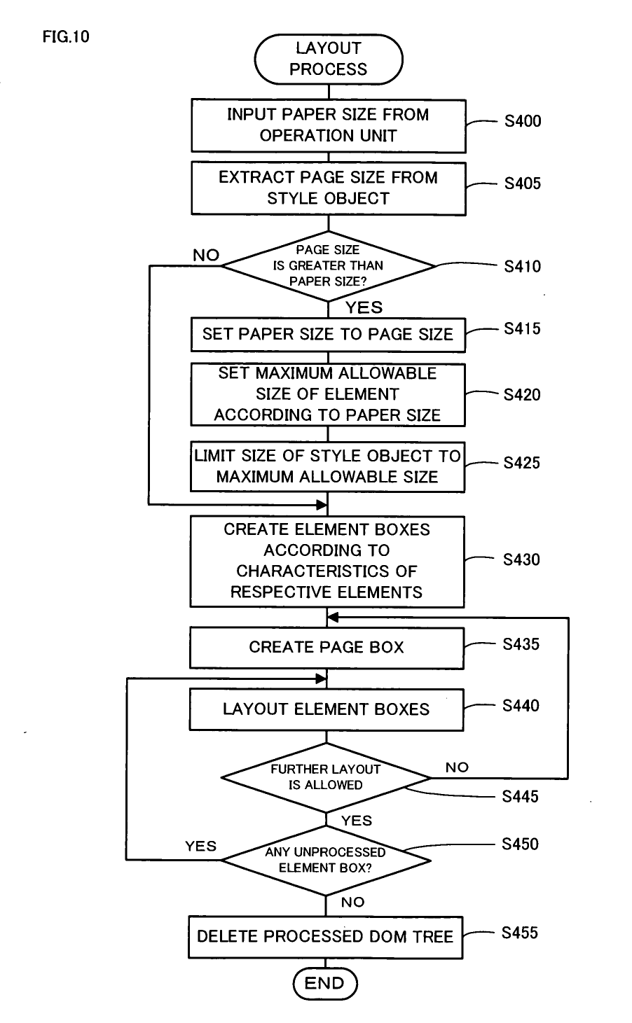

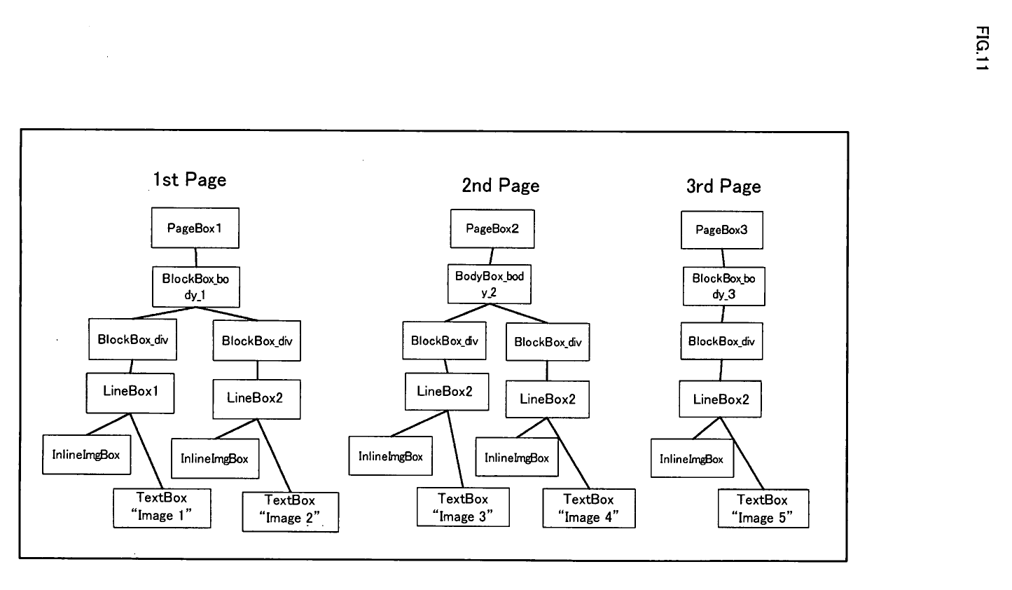

The description regards the series of processing executed by the layouter 38. FIG. 9 is a flowchart showing a layout drawing instruction process executed by the layouter 38 when the analyzer unit 30 specifies a DOM tree and outputs a layout start command. In the layout drawing instruction process, the layouter 38 starts a layout according to the specified DOM tree (step S300). The layout is made according to a layout process shown in the flowchart of FIG. 10. For convenience of explanation, the layout process is described first.

In the layout process, the layouter 38 first inputs the paper size set in the operation unit 60 (step S400) and extracts the page size from the style object correlated with the DOM tree (step S405), and compares the input paper size with the extracted page size (step S410). When the page size is greater than the paper size, the layouter 38 presumes a failure of appropriate layout and sets the paper size to the page size (step S415). The layouter 38 sets a maximum allowable size of an element to be laid out according to the paper size and limits the size of the style object to the maximum allowable size (step S425). The maximum allowable size is defined by the dimensions in the vertical direction and in the lateral direction and is given, for example, by subtracting top, bottom, left, and right margins from the paper size. When the ‘width’ or the ‘height’ of the ‘StyleRule’ shown in FIG. 8 exceeds the maximum allowable size, the limitation of the size of the style object varies the ‘width’ and the ‘height’ to be within the maximum allowable size, while keeping the ratio of the ‘height’ to the ‘width’ unchanged. The unchanged height-to-width ratio effectively prevents an unexpected deformation due to the limitation on in the vertical direction or in the lateral direction. When the paper size is not less than the page size at step S410, the update of the page size and the limitation to the maximum allowable size of the element are skipped. On completion of the required processing based on the comparison between the paper size and the page size, the layouter 38 generates element boxes corresponding to the respective elements included in the DOM tree according to the characteristics of the elements (step S430). For example, an image box is generated corresponding to an image element, while a text box is generated corresponding to a text element. The layouter 38 subsequently creates a page box corresponding to each page according to the page size (step S435) and sequentially lays out the element boxes in a body tag under the page box until prohibition of further layout (steps S440 to S450). The layout of an image box reads an image size limited to the maximum allowable size, sets lines corresponding to the image size, and registers the image box on the lines. When the image size suggests an insufficient space for layout of the image box, further layout is prohibited at step S445. The layouter 38 accordingly creates another page box corresponding to a next page (step S435). The layout of text boxes creates a first text box corresponding to a first part of a text receivable in one line, registers the first text box on the line, creates a next text box corresponding to a next part of the text receivable in a next line, and registers the next text box on the next line. Such creation and registration are repeated to register all the text. In the event of failed registration of all the text to a last text box registered on a last line of one page, further layout is prohibited at step S445. The layouter 38 accordingly creates another page box corresponding to a next page and successively creates text boxes corresponding to the remaining text and registers the text boxes on respective lines in the above manner. FIG. 11 shows page boxes of respective pages as a result of layout according to the DOM tree of the example. After completion of the layout of all the element boxes, the layouter 38 deletes the specified DOM tree as the object of layout from the DOM tree storage area of the memory 50 (step S455) and terminates the layout process. The DOM tree as the object of layout is deleted from the DOM tree storage area of the memory 50 on conclusion of the layout process. This arrangement desirably prevents unnecessary storage of the processed DOM tree in the limited space of the DOM tree storage area and sets a space for storage of another DOM tree created by the analyzer unit 30.

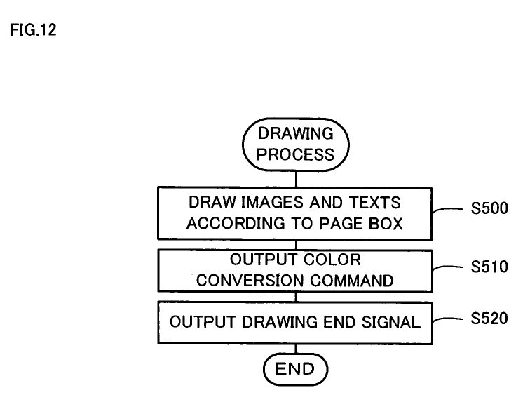

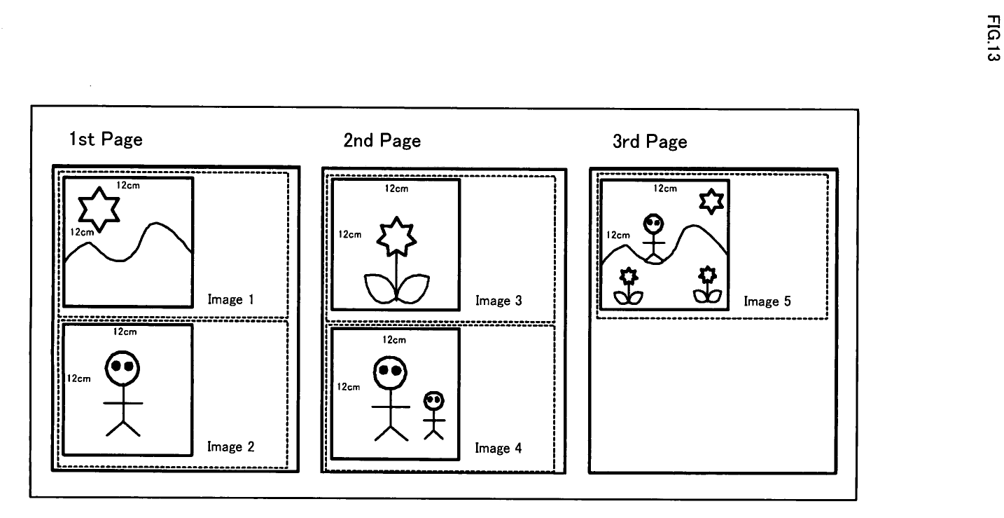

Referring back to the layout drawing instruction process (FIG. 9), the layouter 38 waits for completion of layout in one page (step S310) and specifies the layout page and outputs a drawing start command to the RPI40 (step S320). Completion of layout in one page is detected by determining whether or not a page box corresponding to a next page has been created or whether or not the layout process has been concluded in the case of only one page. The RPI40 receives the drawing start command and executes a drawing process shown in the flowchart of FIG. 12. The RPI40 draws texts and images according to the page box and stores the drawn texts and images as RGB data in the printing image storage area of the memory 50 (step S500). On completion of the drawing, the RPI40 outputs a color conversion command to the color conversion unit 42 (step S510) and outputs a drawing end signal to the layouter 38. The image drawing procedure reads an image file and draws an image with required processing, such as expansion, in some file formats. FIG. 13 shows a printing result of the example. The broken lines represent virtual areas of div tags included in the body tag, and the dimensions ‘12 cm’ shown on the top and the left sides of each image represent the image size described in the CSS document. The actual printing result naturally does not include the areas of the div tags and the image size.

After output of the drawing start command, the layouter 38 waits for completion of drawing on the specified page (step S330) and deletes the page box corresponding to the processed page (step S340). The page box as the object of drawing is deleted on completion of drawing on the corresponding page. This arrangement desirably prevents unnecessary storage of the processed page box in the limited space of a box storage area. After deletion of the processed page box, the layouter 38 determines whether there is a next page to be processed (step S350). When there is a next page to be processed, the processing flow goes back to step S310 to wait for completion of layout in the next page, specify the next layout page, and output a drawing start command to the RPI40. When drawing has been completed on all the pages and there is no other page to be processed, the layouter 38 outputs a layout end signal to the analyzer unit 30 (step S360) and terminates the layout drawing instruction process. The output of the layout end signal from the layouter 38 to the analyzer unit 30 enables the analyzer unit 30 to determine whether the layouter 38 is currently making a layout.

As described above, when the page size extracted from the style object created by analysis of the CSS document is greater than the paper size set by manipulation of the operation unit 60, the color inkjet printer 20 of the embodiment updates the page size to the paper size, limits the size of the style object to the maximum allowable size of the element set according to the paper size, and layouts and prints the elements based on the updated page size and the limited size of the style object. This arrangement desirably prevents potential troubles due to the greater page size than the printing size, for example, failed printing of part of the elements to be printed, thus ensuring appropriate printing of an XHTML document.

Every time a specified URL is given, the color inkjet printer 20 of the embodiment stores the specified URL into the URL storage buffer area of the memory 50, whether or not an XHTML document is being currently analyzed. When any URL is present in the URL storage buffer area of the memory 50, the color inkjet printer 20 successively analyzes XHTML documents, whether or not the layouter 38 is currently making a layout. The color inkjet printer 20 accordingly stores a specified URL and reads and analyzes an XHTML document identified by the specified URL, whether or not the layouter 38 is currently making a layout. This arrangement ensures prompt analysis and printing, compared with the prior art printer system that reads and analyzes a next XHTML document identified by a URL for printing on completion of printing one XHTML document.

In the color inkjet printer 20 of the embodiment, the style object with the name of the CSS document specified by the XHTML document as the style object ID is stored in the flash memory 52. When the date and time of storage of the style object is within a preset time period, the subsequent series of processing is executed with omission of analysis of the CSS document to create a style object. Such omission desirably accelerates the analysis process and ensures higher-speed printing, compared with the conventional processing flow that unconditionally analyzes the CSS document to create a style object. When the date and time of storage of the style object in the flash memory 52 is beyond the preset time period, the processing flow analyzes the CSS document to create a style object. This arrangement desirably prevents the style object beyond the preset time period, that is, the old style object, from being used for printing.

The memory 50 and the flash memory 52 in the color inkjet printer 20 of the embodiment correspond to the data storage module of the invention. The XML purser 34, the CSSPI 36, the core 32, and the layouter 38 are respectively equivalent to the structural analysis module, the style analysis module, the analysis instruction module, and the layout setting module of the invention. The RPI 40, the color conversion unit 42, the binarization unit 44, the image buffer 46, and the print execution unit 48 correspond to the print execution module of the invention.

When the page size extracted from the style object created by analysis of the CSS document is greater than the paper size set by manipulation of the operation unit 60, the color inkjet printer 20 of the embodiment updates the page size to the paper size and limits the size of the style object to the maximum allowable size of the element set according to the paper size. The limitation of the size of the style object to the maximum allowable size of the element may be omitted when not required.

There is no description about margin settings in the color inkjet printer 20 of the embodiment. In the case of selecting rimless printing as the margin settings, the image data size is greater than the paper size. The elements may thus be laid out according to the image data size.

When any URL is present in the URL storage buffer area of the memory 50, the color inkjet printer 20 of the embodiment successively analyzes XHTML documents, regardless of the number of DOM trees stored in the DOM tree storage area of the memory 50. When the number of DOM trees stored in the DOM tree storage area of the memory 50 reaches a preset number, analysis of a next XHTML document may be sustained until the number of the stored DOM trees decreases below the preset number. The preset number is, for example, 2. This arrangement desirably reduces the required capacity of the DOM tree storage area in the memory 50.

When any URL is present in the URL storage buffer area of the memory 50, the color inkjet printer 20 of the embodiment starts analysis of a next XHTML document immediately after completion of analysis of one XHTML document. Analysis of a next XHTML document may start at any desirable timing after completion of analysis of one XHTML document.

Every time a specified URL is given, the color inkjet printer 20 of the embodiment stores the specified URL into the URL storage buffer area of the memory 50, whether or not an XHTML document is being currently analyzed. When any URL is present in the URL storage buffer area of the memory 50, the color inkjet printer 20 of the embodiment sequentially executes analysis of XHTML documents, regardless of execution or non-execution of the layout by the layouter 38. The sequential analysis of XHTML documents may be stopped during execution of a printing operation, for example, during execution of layout. In this modified arrangement, a new URL may be accepted only after conclusion of the printing operation.

When the date and time of storage of the style object in the flash memory 52 is beyond the preset time period, the color inkjet printer 20 of the embodiment analyzes the CSS document to create a style object and overwrite the storage of the style object with the newly created style object. One modified procedure may retrieve and delete the style object stored in the flash memory 52 at a specified timing, for example, at a power-on timing, before elapse of the preset time period. This modified procedure does not determine whether the date and time of storage of the style object in the flash memory 52 is within the preset time period, but unconditionally correlates the analyzed DOM tree with the style object stored in the flash memory 52.

The color inkjet printer 20 of the embodiment has no limit of the number of style objects simultaneously stored in the flash memory 52. A limit may be set for the number of style objects simultaneously stored in the flash memory 52, for example, 5 style objects or 10 style objects. In this modified structure, an oldest style object having the oldest date and time of storage among the limit number of the stored style objects is deleted to give the space for storage of a new style object.

In the color inkjet printer 20 of the embodiment, the style object with the name of the CSS document specified by the XHTML document as the style object ID is stored in the flash memory 52. When the date and time of storage of the style object is within the preset time period, the color inkjet printer 20 of the embodiment executes the subsequent series of processing with omission of analysis of the CSS document to create a style object. One modified procedure may unconditionally analyze the CSS document specified by the XHTML document.

The color inkjet printer 20 of the embodiment analyzes and prints XHTML documents described in XHTML language. The technique of the invention is also applicable to analyze and print documents described in another markup language, as well as documents described in any language other than the markup language.

In the configuration of the embodiment, the computer 10, the digital TV receiver 12, and the digital camera 14 are connected to the input interface 22 of the color inkjet printer 20. Any other suitable devices may be connected with the color inkjet printer 20.

The above embodiment regards the color inkjet printer that analyzes and prints XHTML documents as the printing device of the invention. The technique of the invention is also applicable to diversity of other printers, for example, color laser printers, monochromatic inkjet printers, and monochromatic laser printers.

The preferred embodiment and its modifications discussed above are to be considered in all aspects as illustrative and not restrictive. There may be many other modifications, changes, and alterations without departing from the scope or spirit of the main characteristics of the present invention.

1. A printing device that analyzes a description document, which describes printable objects in a hierarchical manner in a preset first format, and prints the objects on a medium, such as paper, said printing device comprising:
a data storage module that stores data;
a structural analysis module that analyzes a hierarchical tree structure of objects described in a given description document and stores the analyzed tree structure into said data storage module;
a style analysis module that analyzes a style document, which describes a printing style of the objects in a preset second format, and stores style data given as a result of the analysis into said data storage module;
an analysis instruction module that, in response to specification of a description document, gives a structure analysis command to said structural analysis module to analyze the tree structure of the specified description document, gives a style analysis command to said style analysis module to analyze a style document described in the specified description document and generate style data as a result of the analysis, and correlates the analyzed tree structure with the generated style data;
a layout setting module that, in response to a layout command, determines a layout of the objects in each page on the medium, based on the tree structure analyzed and stored in said data storage module, the style data correlated with the tree structure, and a size of the medium, and stores the determined layout in each page into said data storage module; and
a print execution module that, in response to a print command, fetches the objects according to the layout in each page stored in said data storage module and lays out and prints the fetched objects on the medium.

2. A printing method executed in a printing device in response to specification of a description document that describes printable objects in a hierarchical manner in a preset format, to analyze the specified description document and print the objects on a medium, said printing method comprising the steps of:
(a) analyzing a hierarchical tree structure of the objects in the specified description document;
(b) analyzing a style document described in the specified description document to generate style data representing a printing style of the objects as a result of the analysis;
(c) correlating the analyzed tree structure with the generated style data;
(d) in response to a layout command, determining a layout of the objects in each page on the medium, based on the analyzed tree structure, the style data correlated with the tree structure, and a size of the medium; and
(e) in response to a print command, fetching the objects according to the determined layout in each page and laying out and printing the fetched objects on the medium.

3. A printing method in accordance with claim 2, wherein the style data include a page size, and
when the page size included in the style data is greater than the size of the medium, said step (d) determines the layout according to the size of the medium, instead of the page size.

4. A printing method in accordance with claim 3, wherein the style data includes a size of an object, and
when the size of the object included in the style data is greater than a maximum allowable object size corresponding to the size of the medium, said step (d) determines the layout according to the maximum allowable object size, instead of the size of the object.

5. A printing method in accordance with claim 2, wherein in the case of execution of a printing operation of another description document specified prior to specification of a certain description document, said step (a) starts analysis of the tree structure of the certain description document after completion of analysis of the tree structure of the another description document, regardless of execution or non-execution of the printing operation.

6. A printing method in accordance with claim 2, wherein said printing device has a data storage module of storing data,
said step (a) stores the analyzed tree structure into said data storage module, and
in response to the layout command with specification of the tree structure stored in said data storage module, said step (d) determines the layout based on the specified tree structure.

7. A printing method in accordance with claim 6, wherein said step (d) outputs a predetermined termination signal after completion of determination of a layout based on a previously analyzed tree structure, and in response to a next layout command with specification of a currently analyzed tree structure, which is subsequent to the previously analyzed tree structure with the output of the predetermined termination signal, determines a layout based on the currently analyzed tree structure.

8. A printing method in accordance with claim 2, wherein said step (d) gives the print command with regard to each page on completion of determination of the layout for the page.

9. A printing method in accordance with claim 2, wherein said step (d) gives the print command on completion of determination of the layout for one page.

10. A printing method in accordance with claim 2, wherein said printing device has a data storage module of storing data,
said step (b) retrieves style data corresponding to a style document described in the specified description document with identification information allocated to the style document for its identification from said data storage module,
in the case of failed retrieval of the style data corresponding to the described style document from said data storage module, said step (b) executing analysis of the style document and storing the identification information of the analyzed style document in relation to style data generated as a result of analysis of the style document in said data storage module, while in the case of successful retrieval of the style data corresponding to the described style document from said data storage module, omitting analysis of the style document, and
in the case of failed retrieval of the style data corresponding to the style document described in the specified description document with the identification information allocated to the style document for its identification from said data storage module, said step (c) correlating the tree structure analyzed in said step (a) with the style data generated as a result of the analysis in said step (b), while in the case of successful retrieval of the style data corresponding to the described style document from said data storage module, correlating the tree structure analyzed in said step (a) with the corresponding style data.

11. A printing method in accordance with claim 2, wherein said step (d) determines the layout according to selection or non-selection of a borderless printing option.
